(19) United States
(12) Patent Application Publication
(10) Pub. No.: US 2025/0381667 A1
(43) Pub. Date: Dec. 18, 2025

(54) TECHNIQUES FOR VISION-BASED ROBOT CONTROL USING MULTI-VIEW PRETRAINING

(71) Applicant: NVIDIA CORPORATION, Santa Clara, CA (US)

(72) Inventors: Shengyi QIAN, Santa Clara, CA (US); Ankit GOYAL, Seattle, WA (US); Kaichun MO, Kirkland, WA (US); Valts BLUKIS, Seattle, WA (US); Dieter FOX, Seattle, WA (US)

(21) Appl. No.: 19/173,679

(22) Filed: Apr. 8, 2025

Related U.S. Application Data
(60) Provisional application No. 63/661,473, filed on Jun. 18, 2024.

(51) Int. Cl. B25J 9/16; B25J 19/02

(52) U.S. Cl. CPC B25J 9/163; B25J 9/1697; B25J 19/023

(57) ABSTRACT

The disclosed method for training a robot control model includes performing, based on a plurality of multi-view images that have been masked, one or more operations to train a first untrained machine learning model to generate a first trained machine learning model that comprises a trained encoder, where the first trained machine learning model is trained to generate a plurality of reconstructions of the plurality of multi-view images prior to being masked; and performing, based on robot demonstration data, one or more operations to train a second untrained machine learning model that comprises the trained encoder to generate a second trained machine learning model, where the second trained machine learning model is trained to control a robot to perform at least part of a task.

### CROSS-REFERENCE TO RELATED APPLICATIONS

This application claims priority benefit of the U.S. Provisional Patent Application titled, “3D MULTIVIEW PRETRAINING FOR ROBOTIC MANIPULATION,” filed on Jun. 18, 2024, and having Ser. No. 63/661,473. The subject matter of this related application is hereby incorporated herein by reference.

### BACKGROUND

### Technical Field

Embodiments of the present disclosure relate generally to computer science, robotics, artificial intelligence, and machine learning and, more specifically, to techniques for vision-based robot control using multi-view pretraining.

### Description of the Related Art

Vision-based robot control uses cameras and other imaging sensors to guide robotic systems in both structured and unstructured environments. By processing visual information—such as red, green, and blue (RGB) images, depth maps, or point clouds—robots can perceive objects, monitor the surroundings, and adapt to real-time conditions. Vision-based robot control supports a variety of tasks, from grasping and moving objects to assembling parts and interacting with complex scenes. Vision-based robot control often uses machine learning algorithms that interpret camera data to detect obstacles, plan movements, and execute smooth, collision-free trajectories. Vision-based robot control has been widely adopted in industrial automation, including assembly lines, pick-and-place operations, logistics handling, and/or the like. In service robotics, vision-based control can assist in tasks, such as household automation, surgical procedures, and assistive care, where the robot may need to adjust how the robot moves and interacts with objects based on real-time feedback or changes in the surroundings.

Conventional approaches for vision-based robot control often draw on techniques originally developed for language processing, such as masked language modeling, to learn visual representations (e.g., embeddings). One such technique uses a masked autoencoder included in a robot control model, which hides (e.g., masks) random regions of an image or video frame and trains an autoencoder, which is a machine learning model, to predict the masked areas, thereby learning higher-level contextual features that can be applied to robot control. By training the autoencoder to fill in the masked areas, the robot control model learns to interpret and understand the broader context of the entire scene. For example, in a video of someone performing a simple task, such as picking up a mug, certain parts of each frame could be obscured, prompting the robot control model to infer details, such as the shape of the mug or the hand position. The training process helps at least part of the robot control model learn high-level information about objects and the relationships among objects in everyday settings. When the learned information is applied to robot control, the information can guide a robot to detect, grasp, or manipulate objects in real-world environments.

One drawback of the above approaches for vision-based robot control is that masked autoencoders are typically pretrained on only two-dimensional (2D) image data, overlooking the underlying three-dimensional (3D) structure of the scene. While learning from 2D images can capture certain visual patterns and object features, many tasks in robotic manipulation depend on accurate depth and spatial relationships that are lost in purely 2D representations. For example, a robot may need to assess how far an object extends into space or how the object occludes other items in order to plan a safe and precise motion. By focusing solely on 2D, conventional approaches risk misinterpreting partially hidden objects or failing to account for depth cues that are required for tasks such as grasping, stacking, and assembling.

Another drawback of the above approaches for vision-based robot control is that there is often a limited amount of robotics data available for training. A robot control model that is trained on a limited amount of robotics data can become highly specialized to the specific objects, tasks, or environments present in the training data. The specialization reduces the ability of the robot control model to adapt to and correctly control a robot to perform tasks in novel situations or involving different types of objects. As a result, the robot control model can underperform or fail entirely when deployed in real-world conditions that deviate from the scenarios in the training data.

As the foregoing illustrates, what is needed in the art are more effective techniques for vison-based robot control.

### SUMMARY

According to some embodiments, a computer-implemented method for training a robot control model includes performing, based on a plurality of multi-view images that have been masked, one or more operations to train a first untrained machine learning model to generate a first trained machine learning model that comprises a trained encoder, where the first trained machine learning model is trained to generate a plurality of reconstructions of the plurality of multi-view images prior to being masked. The method further includes performing, based on robot demonstration data, one or more operations to train a second untrained machine learning model that comprises the trained encoder to generate a second trained machine learning model, where the second trained machine learning model is trained to control a robot to perform at least part of a task.

Further embodiments provide, among other things, non-transitory computer-readable storage media storing instructions and systems configured to implement the method set forth above.

At least one technical advantage of the disclosed techniques relative to the prior art is that the disclosed techniques generate images from 3D object geometry data rather than 2D image data, allowing a robot control model to understand the underlying 3D structures of scenes. Additionally, the disclosed techniques pretrain a multi-view encoder on large-scale 3D datasets before training a robot control model that includes the multi-view encoder on robotics data, which can be limited. Pretraining the multi-view encoder on large-scale 3D datasets allows the trained robot control model, which includes the multi-view encoder, to generalize to novel situations and objects that are not included in the limited robotics data. Accordingly, the trained robot control model can correctly control a robot to perform tasks in more scenarios than prior art approaches are able to. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, can be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram of a computer system configured to implement one or more aspects of various embodiments;

FIG. 2A is a more detailed illustration of the machine learning server of FIG. 1, according to various embodiments;

FIG. 2B is a more detailed illustration of the computing device of FIG. 1, according to various embodiments;

FIG. 3A illustrates how the model trainer of FIG. 1 trains a multi-view model, according to various embodiments;

FIG. 3B illustrates how the model trainer of FIG. 1 trains a robot control model, according to various embodiments;

FIG. 4 is a more detailed illustration of the robot control application of FIG. 1, according to various embodiments;

FIG. 5 is a flow diagram of method steps for training a robot control model, according to various embodiments;

FIG. 6 is a flow diagram of method steps for training a multi-view model, according to various embodiments;

FIG. 7 is a flow diagram of method steps for training a robot control model using a trained multi-view encoder, according to various embodiments; and

FIG. 8 is the flow diagram of method steps for controlling a robot using a trained robot control model, according to various embodiments.

### DETAILED DESCRIPTION

In the following description, numerous specific details are set forth to provide a more thorough understanding of the various embodiments. However, it will be apparent to one skilled in the art that the concepts can be practiced without one or more of these specific details.

### General Overview

Embodiments of the present disclosure provide techniques for vision-based robot control using multi-view pretraining. In various embodiments, a model trainer trains a robot control model, which is a machine learning model, in two stages. In a first stage, also referred to herein as “pretraining,” the model trainer trains a multi-view model, which is another machine learning model, using object geometry data. In some embodiments, the multi-view model includes a multi-view encoder and a decoder. During the first stage of training, a multi-view renderer processes object geometry data and generates masked multi-view images, which are images rendered using virtual cameras from different viewpoints, and corresponding ground-truth multi-view images. The multi-view encoder processes the masked multi-view images and generates multi-view embeddings. The decoder processes the multi-view embeddings and generates reconstructed multi-view images. A loss calculator compares the reconstructed multi-view images and the ground-truth multi-view images to calculate a first loss, such as a reconstruction loss. The model trainer uses the first loss to iteratively update the parameters of the multi-view model. Once the multi-view model is trained, the model trainer stores the trained multi-view encoder for the second stage of training. In the second stage, the model trainer trains the robot control model using robot demonstration data, which includes multi-view images, language goals, and ground truth robot actions. The robot control model includes the trained multi-view encoder and an action decoder. During the second stage of training, the trained multi-view encoder processes the multi-view images from robot demonstration data and generates multi-view embeddings. The action decoder processes the multi-view embeddings and the language goals and generates robot actions. The loss calculator compares the robot actions and the ground-truth robot actions to calculate a second loss. The model trainer then uses the second loss to iteratively update the parameters of the robot control model. Once the robot control model is trained, the trained robot control model can be used to generate robot actions to cause a robot to perform at least part of a task.

The robot control techniques of the present disclosure have many real-world applications. For example, the robot control techniques could be used to control a physical robot in a real-world environment or a simulated robot in a virtual environment. As another example, the robot control techniques could be used to control other characters having movable joints like a robot.

The above examples are not in any way intended to be limiting. As persons skilled in the art will appreciate, as a general matter, the robot control techniques described herein can be implemented in any suitable application.

### System Overview

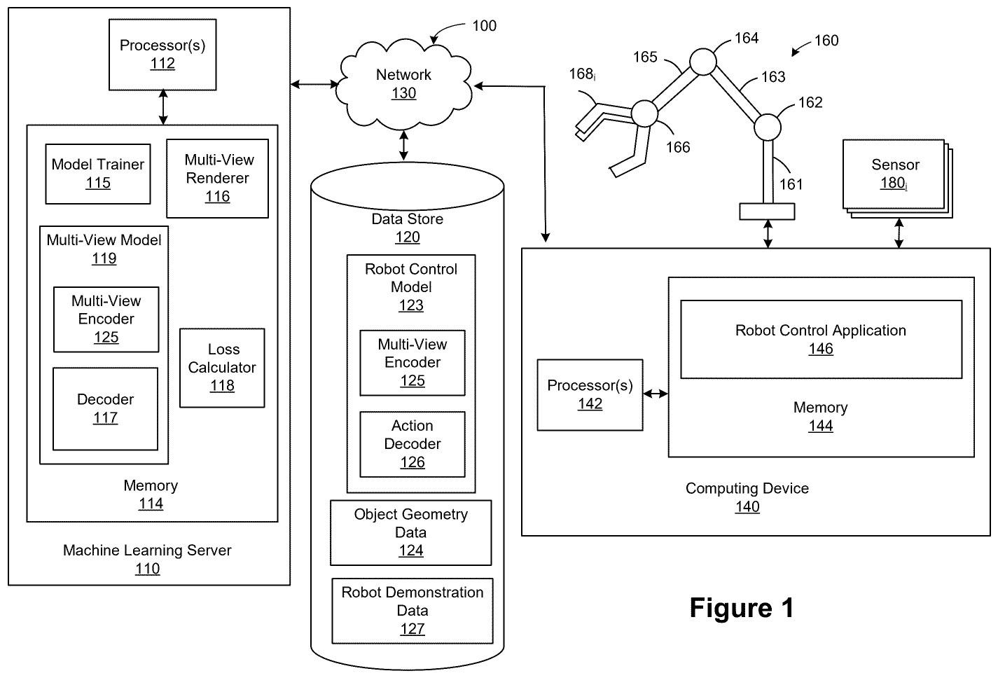

FIG. 1 illustrates a block diagram of a computer-based system 100 configured to implement one or more aspects of at least one embodiment. As shown, system 100 includes a machine learning server 110, a data store 120, and a computing device 140 in communication over a network 130, which can be a wide area network (WAN) such as the Internet, a local area network (LAN), a cellular network, and/or any other suitable network. Machine learning server 110 includes, without limitation, processor(s) 112 and a memory 114. Memory 114 includes, without limitation, a model trainer 115, a multi-view renderer 116, a multi-view model 119, and a loss calculator 118. Multi-view model 119 includes, without limitation, a multi-view encoder 125 and a decoder 117. Data store 120 includes, without limitation, robot control model 123, object geometry data 124, and robot demonstration data 127. Computing device 140 includes, without limitation, processor(s) 142 and a memory 144. Memory 144 includes, without limitation, a robot control application 146.

Processor(s) 112 receive user input from input devices, such as a keyboard or a mouse. Processor(s) 112 may include one or more primary processors of machine learning server 110, controlling and coordinating operations of other system components. In particular, processor(s) 112 can issue commands that control the operation of one or more graphics processing units (GPUs) (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

System memory 114 of machine learning server 110 stores content, such as software applications and data, for use by processor(s) 112 and the GPU(s) and/or other processing units. System memory 114 can be any type of memory capable of storing data and software applications, such as a random-access memory (RAM), a read-only memory (ROM), an erasable programmable read-only memory (EPROM or Flash ROM), or any suitable combination of the foregoing. In some embodiments, a storage (not shown) can supplement or replace the system memory 114. The storage can include any number and type of external memories that are accessible to processor 112 and/or the GPU. For example, and without limitation, the storage can include a Secure Digital Card, an external Flash memory, a portable compact disc read-only memory (CD-ROM), an optical storage device, a magnetic storage device, and/or any suitable combination of the foregoing.

Machine learning server 110 shown herein is for illustrative purposes only, and variations and modifications are possible without departing from the scope of the present disclosure. For example, the number of processors 112, the number of GPUs and/or other processing unit types, the number of system memories 114, and/or the number of applications included in system memory 114 can be modified as desired.

Further, the connection topology between the various units in FIG. 1 can be modified as desired. In some embodiments, any combination of processor(s) 112, system memory 114, and/or GPU(s) can be included in and/or replaced with any type of virtual computing system, distributed computing system, and/or cloud computing environment, such as a public, private, or a hybrid cloud system.

As shown, multi-view renderer 116 executes on one or more processors 112 of machine learning server 110 and is stored in system memory 114 of machine learning server 110. In various embodiments, multi-view renderer 116 is an application that processes object geometry data 124 stored in data store 120 to generate masked multi-view images and ground truth multi-view images. Object geometry data 124, which can be stored in data store 120 or elsewhere (e.g., in memory 114), includes large-scale 3D scene datasets (e.g., Objaverse dataset) which includes one or more geometries (e.g., meshes) of various objects, such as cups, chairs, tools, and mechanical parts, each with varying sizes, shapes, and material properties. In some embodiments, object geometry data 124 includes one or more posed images of objects.

As shown, loss calculator 118 executes on one or more processors 112 of machine learning server 110 and is stored in system memory 114 of machine learning server 110. In various embodiments, loss calculator 118 is an application that calculates a first loss based on reconstructed multi-view images and ground truth multi-view images and calculates a second loss based on robot actions and ground truth robot actions included in robot demonstration data 127.

As shown, model trainer 115 is an application that executes on one or more processors 112 of machine learning server 110 and is stored in a system memory 114 of machine learning server 110. Although shown as distinct from multi-view renderer 116 and loss calculator 118 for illustrative purposes, in some embodiments, functionality of multi-view renderer 116, loss calculator 118, and model trainer 115 can be combined into a single application or separated into any number of applications.

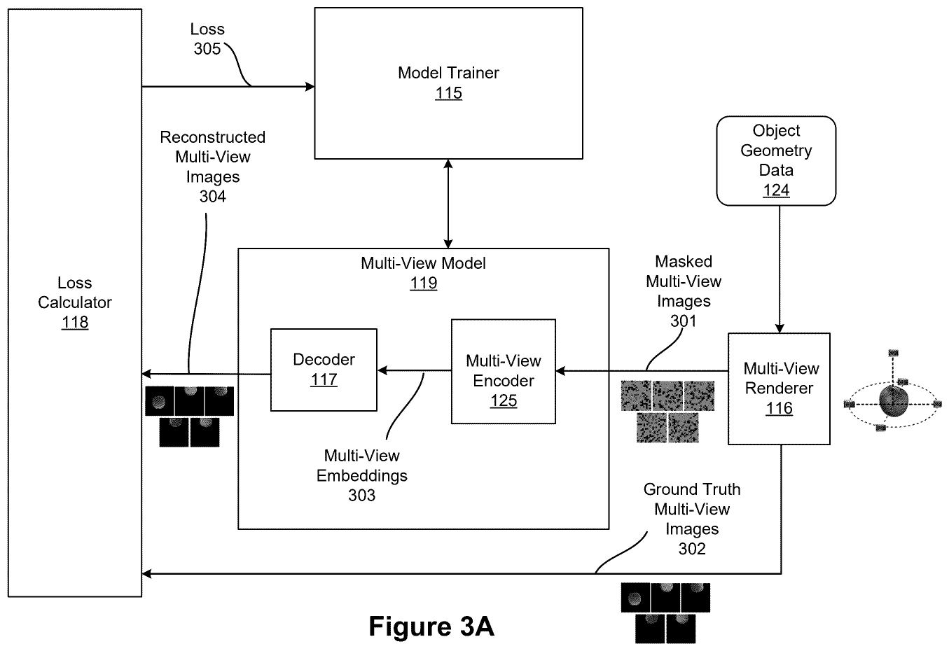

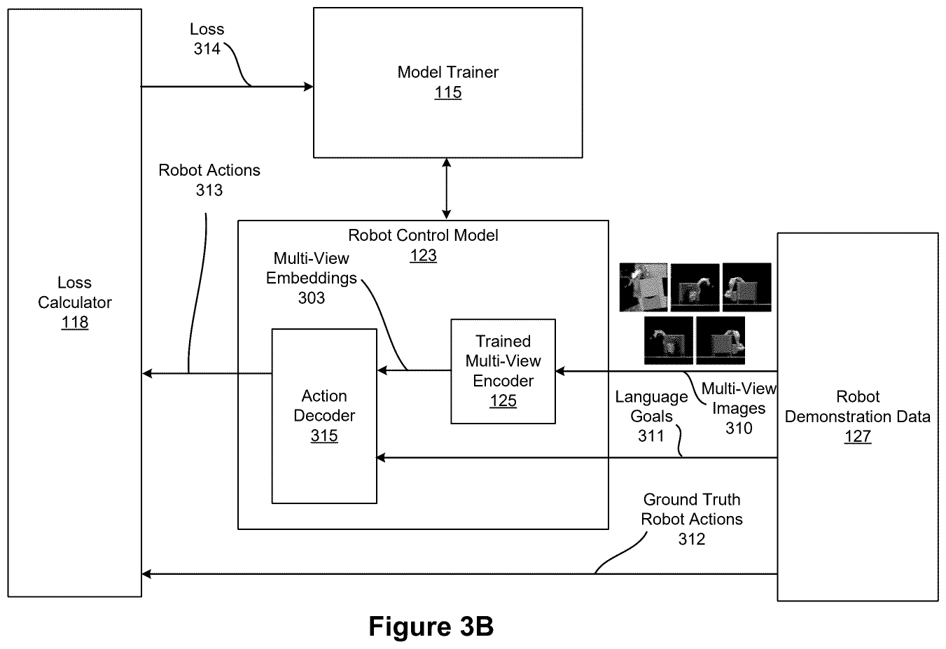

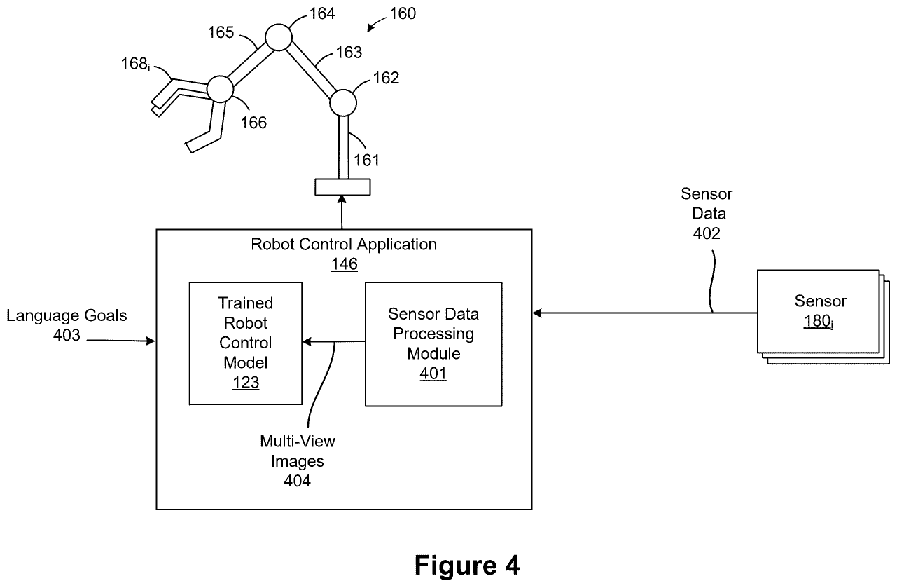

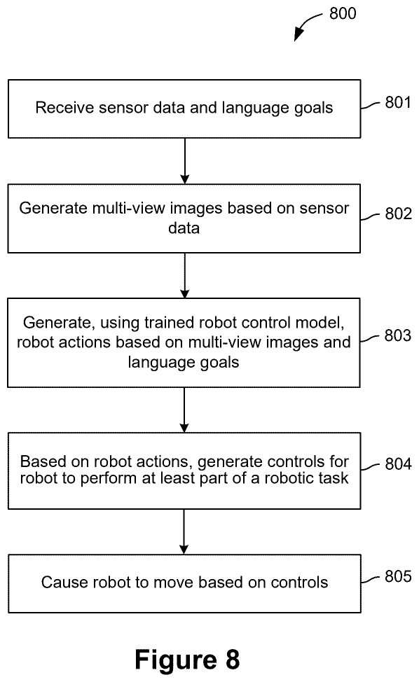

In some embodiments, model trainer 115 is configured to train one or more machine learning models, including multi-view model 119 and robot control model 123. Multi-view model 119 is a machine learning model, such as a neural network, which is trained to generate reconstructed multi-view images based on one or more masked multi-view images. Robot control model 123 is another machine learning model, such as a neural network, which processes language goals received via one or more I/O devices (not shown) and multi-view images generated from sensor data acquired via one or more sensors 180ᵢ (referred to herein collectively as sensors 180 and individually as a sensor 180), and generates robot actions as discussed in greater detail below in conjunction with FIGS. 4 and 8. For example, in at least one embodiment, sensors 180 can include one or more cameras, one or more RGB-D cameras (e.g., cameras using time-of-flight sensors), such as a wrist-mounted RGB-D camera, one or more LiDAR sensors, any combination thereof, etc. Techniques for training multi-view model 119 based on object geometry data 124 and training robot control model 123 based on robot demonstration data 127 are discussed in greater detail herein in conjunction with at least FIGS. 3A-3B and 5-7. Robot control model 123 can be stored in data store 120. In some embodiments, data store 120 can include any storage device or devices, such as fixed disc drive(s), flash drive(s), optical storage, network attached storage (NAS), and/or a storage area-network (SAN). Although shown as accessible over network 130, in at least one embodiment machine learning server 110 can include data store 120.

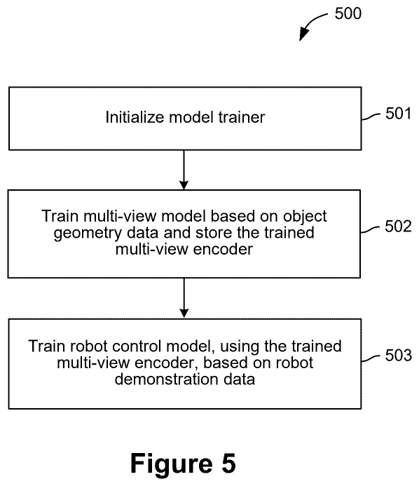

As shown, a robot control application 146 uses robot control model 123, which is stored in data store 120 and accessed over network 130, and executes on processor(s) 142, of computer device 140. Once trained, trained robot control model 123 can be deployed, such as via robot control application 146, to control a physical robot in a real-world environment, such as robot 160. In various embodiments, trained robot control model 123 is deployed for use with virtual environments, such as in a simulator (not shown), where a virtual model of robot 160 is simulated within a virtual environment, such as a digital twin or a simulation platform. In the virtual deployment, robot control application 146 interfaces with a virtual representation of robot 160, which can enable testing, validation, and refinement of robot plans. Memory 144 and the processor(s) 142 can be similar to memory 114 and processor(s) 112 of machine learning server 110, described above. Robot control application 146 is discussed in greater detail below in conjunction with FIGS. 5 and 8.

As shown, robot 160 includes multiple links 161, 163, and 165 that are rigid members, as well as joints 162, 164, and 166 that are movable components that can be actuated to cause relative motion between adjacent links. In addition, robot 160 includes multiple fingers 168ᵢ (referred to herein collectively as fingers 168 and individually as a finger 168) that can be controlled to grasp an object. For example, in at least one embodiment, robot 160 can include a locked wrist and multiple (e.g., four) fingers. Although an example robot 160 is shown for illustrative purposes, in at least one embodiment, techniques disclosed herein can be applied to control any suitable robot.

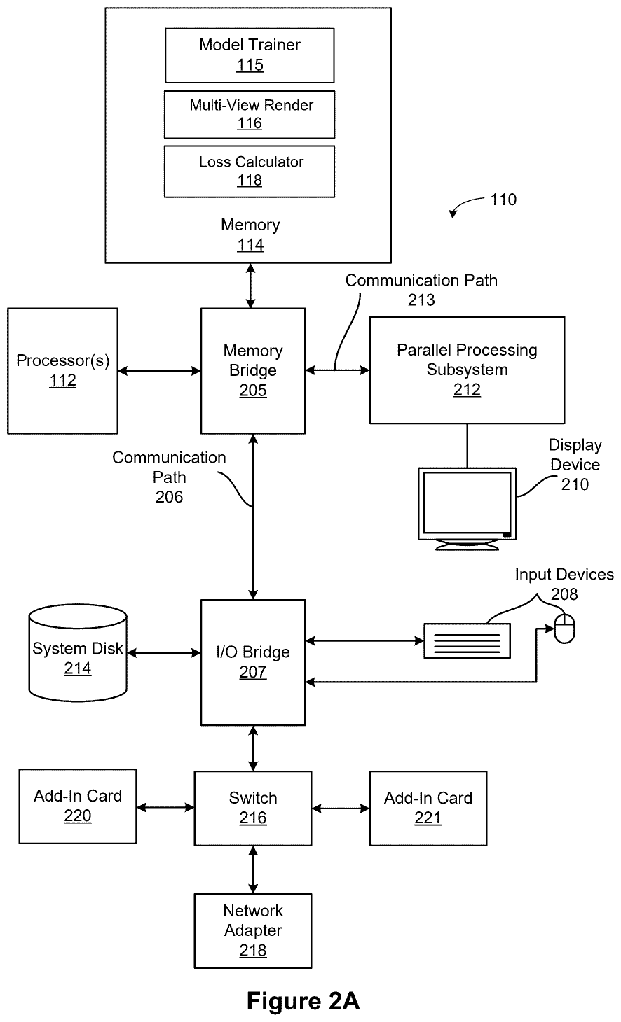

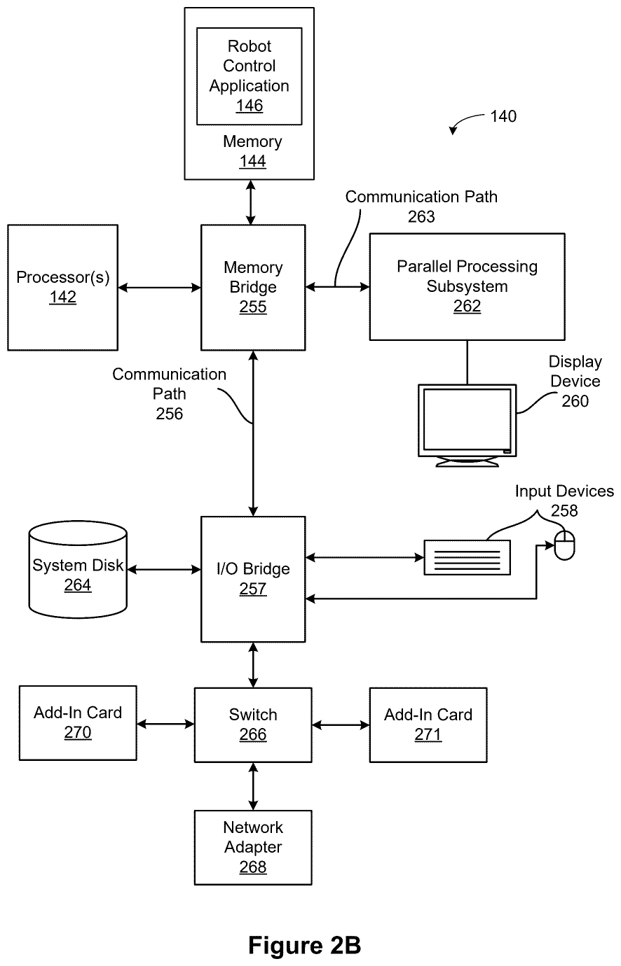

FIG. 2A is a more detailed illustration of machine learning server 110 of FIG. 1, according to various embodiments. Machine learning server 110 may include any type of computing system, including, without limitation, a server machine, a server platform, a desktop machine, a laptop machine, a hand-held/mobile device, a digital kiosk, an in-vehicle infotainment system, and/or a wearable device. In some embodiments, machine learning server 110 is a server machine operating in a data center or a cloud computing environment that provides scalable computing resources as a service over a network.

In various embodiments, machine learning server 110 includes, without limitation, processor(s) 112 and memory(ies) 114 coupled to a parallel processing subsystem 212 via a memory bridge 205 and a communication path 213. Memory bridge 205 is further coupled to an I/O (input/output) bridge 207 via a communication path 206, and I/O bridge 207 is, in turn, coupled to a switch 216.

In one embodiment, I/O bridge 207 is configured to receive user input information from optional input devices 208, such as a keyboard, mouse, touch screen, sensor data analysis (e.g., evaluating gestures, speech, or other information about one or more uses in a field of view or sensory field of one or more sensors), and/or the like, and forward the input information to processor(s) 112 for processing. In some embodiments, machine learning server 110 may be a server machine in a cloud computing environment. In such embodiments, machine learning server 110 may not include input devices 208, but may receive equivalent input information by receiving commands (e.g., responsive to one or more inputs from a remote computing device) in the form of messages transmitted over a network and received via network adapter 218. In some embodiments, switch 216 is configured to provide connections between I/O bridge 207 and other components of machine learning server 110, such as a network adapter 218 and various add-in cards 220 and 221.

In some embodiments, I/O bridge 207 is coupled to a system disk 214 that may be configured to store content and applications and data for use by processor(s) 142 and parallel processing subsystem 212. In one embodiment, system disk 214 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 207 as well.

In various embodiments, memory bridge 205 may be a Northbridge chip, and I/O bridge 207 may be a Southbridge chip. In addition, communication paths 206 and 213, as well as other communication paths within machine learning server 110, may be implemented using any technically suitable protocols, including, without limitation, AGP (Accelerated Graphics Port), HyperTransport, or any other bus or point-to-point communication protocol known in the art.

In some embodiments, parallel processing subsystem 212 comprises a graphics subsystem that delivers pixels to an optional display device 210 that may be any conventional cathode ray tube, liquid crystal display, light-emitting diode display, and/or the like. In such embodiments, parallel processing subsystem 212 may incorporate circuitry optimized for graphics and video processing, including, for example, video output circuitry. Such circuitry may be incorporated across one or more parallel processing units (PPUs), also referred to herein as parallel processors, included within parallel processing subsystem 212.

In some embodiments, parallel processing subsystem 212 incorporates circuitry optimized (e.g., that undergoes optimization) for general purpose and/or compute processing. Again, such circuitry may be incorporated across one or more PPUs included within parallel processing subsystem 212 that are configured to perform such general purpose and/or compute operations. In yet other embodiments, the one or more PPUs included within parallel processing subsystem 212 may be configured to perform graphics processing, general purpose processing, and/or compute processing operations. System memory 114 includes at least one device driver configured to manage the processing operations of the one or more PPUs within parallel processing subsystem 212. In addition, system memory 114 includes, without limitation, model trainer 115, multi-view renderer 116, and loss calculator 118. Although described herein primarily with respect to model trainer 115, multi-view renderer 116, and loss calculator 118, techniques disclosed herein can also be implemented, either entirely or in part, in other software and/or hardware, such as in parallel processing subsystem 212.

In various embodiments, parallel processing subsystem 212 may be integrated with one or more of the other elements of FIG. 2A to form a single system. For example, parallel processing subsystem 212 may be integrated with processor 142 and other connection circuitry on a single chip to form a system on a chip (SoC).

In some embodiments, processor(s) 112 includes the primary processor of machine learning server 110, controlling and coordinating operations of other system components. In some embodiments, processor(s) 112 issues commands that control the operation of PPUs. In some embodiments, communication path 213 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 112, and the number of parallel processing subsystems 212, may be modified as desired. For example, in some embodiments, system memory 114 could be connected to the processor(s) 112 directly rather than through memory bridge 205, and other devices may communicate with system memory 114 via memory bridge 205 and processor 112. In other embodiments, parallel processing subsystem 212 may be connected to I/O bridge 207 or directly to processor 112, rather than to memory bridge 205. In still other embodiments, I/O bridge 207 and memory bridge 205 may be integrated into a single chip instead of existing as one or more discrete devices. In certain embodiments, one or more components shown in FIG. 2A may not be present. For example, switch 216 could be eliminated, and network adapter 218 and add-in cards 220, 221 would connect directly to I/O bridge 207. Lastly, in certain embodiments, one or more components shown in FIG. 2A may be implemented as virtualized resources in a virtual computing environment, such as a cloud computing environment. In particular, the parallel processing subsystem 212 may be implemented as a virtualized parallel processing subsystem in at least one embodiment. For example, the parallel processing subsystem 212 may be implemented as a virtual graphics processing unit(s) (vGPU(s)) that renders graphics on a virtual machine(s) (VM(s)) executing on a server machine(s) whose GPU(s) and other physical resources are shared across one or more VMs.

FIG. 2B is a more detailed illustration of computing device 140 of FIG. 1, according to various embodiments. Computing device 140 may include any type of computing system, including, without limitation, a server machine, a server platform, a desktop machine, a laptop machine, a hand-held/mobile device, a digital kiosk, an in-vehicle infotainment system, and/or a wearable device. In some embodiments, computing device 140 is a server machine operating in a data center or a cloud computing environment that provides scalable computing resources as a service over a network. In some embodiments, machine learning server 110 can include one or more similar components as computing device 140.

In various embodiments, computing device 140 includes, without limitation, processor(s) 142 and memory(ies) 144 coupled to a parallel processing subsystem 262 via a memory bridge 255 and a communication path 263. Memory bridge 255 is further coupled to an I/O (input/output) bridge 257 via a communication path 256, and I/O bridge 257 is, in turn, coupled to a switch 266.

In one embodiment, I/O bridge 257 is configured to receive user input information from optional input devices 258, such as a keyboard, mouse, touch screen, sensor data analysis (e.g., evaluating gestures, speech, or other information about one or more uses in a field of view or sensory field of one or more sensors), and/or the like, and forward the input information to processor(s) 142 for processing. In some embodiments, computing device 140 may be a server machine in a cloud computing environment. In such embodiments, computing device 140 may not include input devices 258, but may receive equivalent input information by receiving commands (e.g., responsive to one or more inputs from a remote computing device) in the form of messages transmitted over a network and received via network adapter 268. In some embodiments, switch 266 is configured to provide connections between I/O bridge 257 and other components of computing device 140, such as a network adapter 268 and various add-in cards 270 and 271.

In some embodiments, I/O bridge 257 is coupled to a system disk 264 that may be configured to store content and applications and data for use by processor(s) 142 and parallel processing subsystem 262. In one embodiment, system disk 264 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 257 as well.

In various embodiments, memory bridge 255 may be a Northbridge chip, and I/O bridge 257 may be a Southbridge chip. In addition, communication paths 256 and 263, as well as other communication paths within computing device 140, may be implemented using any technically suitable protocols, including, without limitation, AGP (Accelerated Graphics Port), HyperTransport, or any other bus or point-to-point communication protocol known in the art.

In some embodiments, parallel processing subsystem 262 comprises a graphics subsystem that delivers pixels to an optional display device 260 that may be any conventional cathode ray tube, liquid crystal display, light-emitting diode display, and/or the like. In such embodiments, parallel processing subsystem 262 may incorporate circuitry optimized for graphics and video processing, including, for example, video output circuitry. Such circuitry may be incorporated across one or more parallel processing units (PPUs), also referred to herein as parallel processors, included within parallel processing subsystem 262.

In some embodiments, parallel processing subsystem 262 incorporates circuitry optimized (e.g., that undergoes optimization) for general purpose and/or compute processing. Again, such circuitry may be incorporated across one or more PPUs included within parallel processing subsystem 262 that are configured to perform such general purpose and/or compute operations. In yet other embodiments, the one or more PPUs included within parallel processing subsystem 262 may be configured to perform graphics processing, general purpose processing, and/or compute processing operations. System memory 144 includes at least one device driver configured to manage the processing operations of the one or more PPUs within parallel processing subsystem 262. In addition, system memory 144 includes robot control application 146. Although described herein primarily with respect to robot control application 146, techniques disclosed herein can also be implemented, either entirely or in part, in other software and/or hardware, such as in parallel processing subsystem 262.

In various embodiments, parallel processing subsystem 262 may be integrated with one or more of the other elements of FIG. 2B to form a single system. For example, parallel processing subsystem 262 may be integrated with processor 142 and other connection circuitry on a single chip to form a system on a chip (SoC).

In some embodiments, processor(s) 142 includes the primary processor of computing device 140, controlling and coordinating operations of other system components. In some embodiments, processor(s) 142 issue commands that control the operation of PPUs. In some embodiments, communication path 263 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 142, and the number of parallel processing subsystems 262, may be modified as desired. For example, in some embodiments, system memory 144 could be connected to processor(s) 142 directly rather than through memory bridge 255, and other devices may communicate with system memory 144 via memory bridge 255 and processor 142. In other embodiments, parallel processing subsystem 262 may be connected to I/O bridge 257 or directly to processor 142, rather than to memory bridge 255. In still other embodiments, I/O bridge 257 and memory bridge 255 may be integrated into a single chip instead of existing as one or more discrete devices. In certain embodiments, one or more components shown in FIG. 2B may not be present. For example, switch 266 could be eliminated, and network adapter 268 and add-in cards 270, 271 would connect directly to I/O bridge 257. Lastly, in certain embodiments, one or more components shown in FIG. 2B may be implemented as virtualized resources in a virtual computing environment, such as a cloud computing environment. In particular, parallel processing subsystem 262 may be implemented as a virtualized parallel processing subsystem in at least one embodiment. For example, parallel processing subsystem 262 may be implemented as a virtual graphics processing unit(s) (vGPU(s)) that renders graphics on a virtual machine(s) (VM(s)) executing on a server machine(s) whose GPU(s) and other physical resources are shared across one or more VMs.

### Robot Control Model Training With Multi-View Encoder Pretraining

FIG. 3A illustrates how model trainer 115 of FIG. 1 trains multi-view model 119, according to various embodiments. As shown, multi-view model 119 includes, without limitation, a multi-view encoder 125 and a decoder 117. In operation, multi-view renderer 116 processes object geometry data 124 and generates masked multi-view images 301 and ground truth multi-view images 302. Multi-view encoder 125 processes masked multi-view images 301 and generates multi-view embeddings 303. Decoder 117 processes multi-view embeddings 303 and generates reconstructed multi-view images 304. Loss calculator 118 compares reconstructed multi-view images 304 and ground truth multi-view images 302 and calculates a loss 305. Model trainer 115 uses loss 305 to iteratively update the parameters of multi-view model 119. In various embodiments, once model trainer 115 trains multi-view model 119, the multi-view encoder 125 included in the trained multi-view model 119 is used in robot control model 123 in the second stage of training. In the second stage of training, model trainer 115 trains robot control model 123, which includes the trained multi-view encoder 125, based on robot demonstration data. The second stage of training is described in greater detail in conjunction with FIG. 3B.

As described, multi-view renderer 116 processes object geometry data 124 and generates masked multi-view images 301 and ground truth multi-view images 302. Ground truth multi-view images 302 include a set of images, rendered from multiple viewpoints, of a point cloud generated from the object geometry data 124. Masked multi-view images 301 include the same a set of images that are rendered from multiple viewpoints, except random visual tokens are masked out from each image. In some embodiments, multi-view renderer 116 [symbol] maps one or more posed images included in object geometry data 124 into one or more virtual images (e.g., ground truth multi-view images 301), by constructing a point cloud and rendering the point cloud from one or more views. In various embodiments, multi-view renderer 116 is agnostic to the poses of the red, green, blue, and depth (RGBD) virtual cameras used to construct the point cloud. For example, the point cloud can be obtained from a combination of third-person cameras around the workspace surrounding an object included in object geometry data 124. Multi-view renderer 116 then renders the point cloud using the one or more virtual cameras placed at orthogonal locations around the object, such as virtual cameras placed at the top, left, right, front, and back of the object. In some examples, each virtual image includes a plurality of channels (e.g., 10 channels) including RGB channels (e.g., 3 channels), depth channels (e.g., 1 channel), 3D point coordinate in world frame channels (e.g., 3 channels), and 3D point coordinate channels in camera sensor frame (e.g., 3 channels). The virtual images (e.g., ground truth multi-view images 301) captured from various virtual camera poses {p₁, . . . , p_{N}} are denoted as {I₁, . . . , I_{N}}, where N is the number of one or more views. In some embodiments, multi-view renderer 116 randomly masks out a subset of visual tokens included in one or more virtual images {I₁, . . . , I_{N}} and generates masked multi-view images 301

$$\{ {I}_{1}^{′} , … , {I}_{N}^{′} \} .$$

For example, multi-view renderer 116 could tokenize virtual images using 10×10 pixel patches and apply a masking probability of 0.75 to the patches.

Multi-view model 119 is a machine learning model, such as a neural network, which processes masked multi-view images 301 and generates reconstructed multi-view images 304. As shown, multi-view model 119 includes, without limitation, multi-view encoder 125 and decoder 117. Multi-view encoder 125 is a machine learning model, such as a transformer, which processes masked multi-view images 301 and generates multi-view embeddings 303. In some embodiments, multi-view encoder 125 [symbol] maps masked multi-view images 301 into a latent embedding z∈ [symbol] , where H is the hidden size and M is the number of embeddings, described as

$$z = ε ( \{ {I}_{1}^{′} , … , {I}_{N}^{′} \} ) . \qquad ( Equation 1 )$$

In some examples, multi-view encoder 125 can include a transformer with 8 layers, 8 attention heads, and a hidden dimension of 1024. Decoder 117 is a machine learning model, such as a masked autoencoder, which processes multi-view embeddings 303 and generates reconstructed multi-view images 304. In some embodiments, decoder 117 includes a lightweight masked autoencoder [symbol] which reconstructs the multi-view image {I₁, . . . , I_{S}} from the embedding z given by

$$\{ {\tilde{I}}_{1} , … , {\tilde{I}}_{5} \} = {𝒟}_{MAE} ( z ) , \qquad ( Equation 2 )$$

where {Ĩ₁, . . . , Ĩ_{N}} are the reconstructed multi-view images 304. In some examples, decoder 117 can include a multi-view transformer with 2 layers, 8 attention heads, and a hidden layer dimension of 1024.

Loss calculator 118 compares reconstructed multi-view images 304 and ground truth multi-view images 302 and calculates loss 305. In some examples, loss calculator 118 calculates a pixel-wise reconstruction loss described as

$${ℒ}_{recon} = \frac{1}{NWH} {\sum }_{i = 1}^{N} {\sum }_{p = 1}^{W \cdot H} {‖ {[ {I}_{i} ]}_{( p )} - {[ {\tilde{I}}_{i} ]}_{( p )} ‖}_{2}^{2} , \qquad ( Equation 3 )$$

where [I]₍ₚ₎ indexes the image I∈ [symbol] at pixel p.

Model trainer 115 uses loss 305 to update the parameters of multi-view model 119. In various embodiments, model trainer 115 trains multi-view model 119 to jointly learn to reconstruct all ground truth multi-view images 302, and masking patterns are varied during training. In some embodiments, model trainer 115 splits object geometry data 124 into a training set and a validation set. For example, model trainer 115 could use 200000 3D models of objects included in object geometry data 124 for training and 1000 3D models of objects for validation. In some embodiments, model trainer 115 processes the training set in batches, where each batch consists of a small subset of the training set. For example, model trainer 115 could use a batch size of 3, meaning that three samples are processed in parallel before updating the parameters of multi-view model 119. In some embodiments, model trainer 115 uses various optimization techniques, such as Adaptive Moment Estimation with Weight Decay (AdamW), to update the parameters of multi-view model 119 based on loss 305. In some examples, model trainer 115 uses a learning rate of 0.0001 and a weight decay of 0.01 for AdamW optimization. In some embodiments, model trainer 115 determines when to stop training multi-view model 119 based on various predefined stopping criteria. For example, model trainer 115 can train multi-view model 119 for a fixed number of epochs, such as 15 epochs. In some other embodiments, model trainer 115 can use an early stopping mechanism, where training stops whenever the loss does not improve for a certain number of consecutive epochs, which prevents overfitting and permits that multi-view model 119 does not continue training beyond the point of diminishing returns. Additionally, model trainer 115 can monitor other metrics for stopping, such as reconstruction accuracy or generalization performance. Once model trainer 115 trains multi-view model 119, model trainer 115 stores the trained multi-view encoder 125 in datastore 120 or elsewhere.

FIG. 3B illustrates how the model trainer 115 of FIG. 1 trains a robot control model 123, according to various embodiments. As shown, robot control model 123 includes, without limitation, the trained multi-view encoder 125 and an action decoder 126. In operation, the trained multi-view encoder 125 processes multi-view images 310 included in robot demonstration data 127 and generates multi-view embeddings 303. Action decoder 126 processes language goals 311 included in robot demonstration data 127 and multi-view embeddings 303 and generates robot actions 313. Loss calculator 118 compares robot actions 313 and ground truth robot actions 312 included in robot demonstration data 127 and calculates loss 314. Model trainer 115 uses loss 314 to update the parameters of robot control model 123.

Robot demonstration data 127 includes, without limitation, multi-view images 310, language goals 311, and ground truth robot actions 312. Multi-view images 310 include a combination of images taken using one or more third-person virtual cameras around the workspace of a robot, robot head cameras, or robot wrist cameras. The virtual cameras can be placed at the top, left, right, front, and back of the robot workspace with respect to the robot. Language goals 311 L represent task descriptions or high-level instructions provided in natural language, specifying the intended robot action or outcome of a robotic task. For example, language goals 311 can include instructions such as “pick up the red block,” “place the cup on the table,” or “push the button.” Ground truth robot actions 312 include recorded motion trajectories, end-effector positions, joint angles, gripper states, and other relevant robot actions that demonstrate how a robot completes a task. For example, ground truth robot actions 312 can be collected from a physical robot, human teleoperation, scripted robot policies, or a virtual robot in a simulation environment. In some embodiments, ground truth robot actions 312 include position aₚₒₛ and rotation aᵣₒₜ values for the end-effector of a robot, as well as whether the robot gripper should be open or closed at each timestep denoted by aₒₚₑₙ∈{0,1}.

Robot control model 123 is a machine learning model, such as a neural network, which processes multi-view images 310 and language goals 311 and generates robot actions 313. In various embodiments, robot control model 123 includes a multi-view transformer represented by a parametrized function ƒ_{θ} that maps the virtual images {I₁, . . . , I_{N}} from various virtual camera poses {p₁, . . . , p_{N}} as well as language instructions L to the 6-degree of freedom (DoF) end-effector pose and the binary open or close state of the robot gripper described as

$${a}_{pos} , {a}_{rot} , {a}_{open} = {f}_{θ} ( L , {I}_{1} , {p}_{1} , … , {I}_{N} , {p}_{N} ) . \qquad ( Equation 4 )$$

As shown, robot control model 123 includes, without limitation, the trained multi-view encoder 125 and action decoder 126. The trained multi-view encoder 125 processes multi-view images 310 and generates multi-view embeddings 303. In some examples, the trained multi-view encoder 125 [symbol] generates multi-view embeddings 303 z based on multi-view images 310 I₁, . . . , I_{N} given by

$$z = ε ( {I}_{1} , … , {I}_{N} ) . \qquad ( Equation 5 )$$

Action decoder 126 is a machine learning model, such as a transformer, which processes multi-view embeddings 303 and language goals 311 and generates robot actions 313. In some embodiments, action decoder 315 is relatively lightweight. In some examples, action decoder 126 [symbol] maps multi-view embeddings 303 z to robot actions 313 described as

$${a}_{pos} , {a}_{rot} , {a}_{open} = 𝒟 ( L , z ) . \qquad ( Equation 6 )$$

Loss calculator 118 compares robot actions 313 with ground truth robot actions 312 and calculates loss 314. In some embodiments, loss calculator 118 computes loss 314 using a combination of loss functions tailored to various aspects of robot actions 313. In some examples, for rotation, loss calculator 118 calculates a cross-entropy loss function applied to each of the Euler angles to minimize the difference between predicted rotations included in robot actions 313 and ground-truth rotations included in ground truth robot actions 312. For the gripper state, loss calculator 118 applies a binary classification loss. In some embodiments, loss calculator 118 calculates a binary classification loss for a collision indicator, which predicts whether the robot action 313 would result in a collision with an object or the environment.

Model trainer 115 uses loss 314 to update the parameters of robot control model 123. In some embodiments, model trainer 115 uses various optimization techniques, such as Layer-wise Adaptive Moments optimizer for Batch training (Lamb), to update the parameters of robot control model 123. In some embodiments, model trainer 115 uses robot demonstration data 127 in fixed-size batches (e.g., batches of size 3) during training. In some embodiments, model trainer 115 trains robot control model 123 using a small learning rate (e.g., 1e-4) with a warmup phase to stabilize early training. In some embodiments, model trainer 115 determines when to stop training robot control model 123 based on various predefined stopping criteria. For example, model trainer 115 could train robot control model 123 for a fixed number of epochs. In some embodiments, model trainer 115 implements an early stopping mechanism, where training halts when a loss does not improve for a specified number of consecutive epochs. Additionally, model trainer 115 can monitor performance metrics such as task success rate, robot trajectory accuracy, and action prediction consistency to determine when the robot control model 123 has converged. Once model trainer 115 trains robot control model 123, model trainer 115 stores the trained robot control model 123 in data store 120 or elsewhere.

### Robot Control Model Using Trained Robot Control Model

FIG. 4 is a more detailed illustration of the robot control application 146 of FIG. 1, according to various embodiments. As shown, robot control application 146 includes, without limitation, sensor data processing module 401 and the trained robot control model 123. Robot control application 146 uses the trained robot control model 123 to process language goals 403 received from one or more I/O devices (not shown) and sensor data 402 received from sensors 180 to generate controls to cause robot 160 to perform at least part of a task. Similar to language goals 311, language goals 403 represent task descriptions or high-level instructions provided in natural language, specifying the intended robot action or outcome of a robotic task.

Sensor data processing module 401 processes sensor data 402 and generates multi-view images 404. In some embodiments, sensor data processing module 401 normalizes and preprocesses multi-view images 404 before passing multi-view images 404 to the trained robot control model 123. The preprocessing can include depth normalization, background filtering, image resizing, and/or applying transformations to align images across different viewpoints. In some embodiments, multi-view images 404 include RGB-D (red, blue, green, and depth) images generated using one or more virtual cameras from different viewpoints. In such cases, sensors 180 can include cameras positioned on and/or around the robot, such as head-mounted cameras, wrist cameras, and/or external third-person cameras placed at predefined viewpoints, and the cameras can capture RGB and depth data that sensor data processing module 401 maps into one or more virtual images (e.g., multi-view images 404) by constructing a point cloud and rendering the point cloud from one or more views using virtual cameras at predefined locations (e.g., top, left, right, front, and back virtual cameras), similar to the description above with respect to the multi-view renderer 116 in FIG. 3A.

Trained robot control model 123 processes multi-view images 404 and language goals 403 and generates robot actions. Robot control application 146 processes the robot actions and generates one or more controls for robot 160 to complete at least part of a task. In some embodiments, robot control application 146 uses various motion planning techniques, such as inverse kinematics and/or the like, to generate one or more controls based on the robot actions. The controls can include joint position commands, velocity commands, or torque commands, depending on the specific motion control architecture of robot 160. In some embodiments, robot control application 146 includes real-time feedback from sensors 180 to dynamically adjust the robot actions based on unexpected changes in the environment, such as the displacement of objects or obstacles. In some embodiments, robot control application 146 sends low-level motor commands to the actuators of robot 160 based on the controls, or sends commands based on the controls to a low-level controller that generates low-level motor commands, enabling precise execution of the controls.

FIG. 5 is a flow diagram of method steps for training a robot control model 123, according to various embodiments. Although the method steps are described in conjunction with the systems of FIGS. 1-4, persons skilled in the art will understand that any system configured to perform the method steps in any order falls within the scope of the present disclosure.

As shown, a method 500 begins with step 501, where model trainer 115 is initialized. In some embodiments, model trainer 115 initializes various hyperparameters, such as learning rate, batch size, weight decay, and optimization settings. For example, model trainer 115 could initialize a learning rate of 1e-4 with a warmup phase to stabilize early training, a batch size of 3, and a weight decay of 0.01 when using the Lamb optimization technique. Additionally, model trainer 115 can define the number of training epochs, such as 15 epochs, and set a masking probability of 0.75 for masked autoencoding. Initialization can also include setting up the training dataset, such as selecting 200,000 3D object models from object geometry data 124 for training and 1,000 3D object models for validation. Model trainer 115 can also initialize the number of layers, such as 8 layers, 8 attention heads, and a hidden layer dimension of 1024 for multi-view encoder 125, and 2 layers for decoder 117.

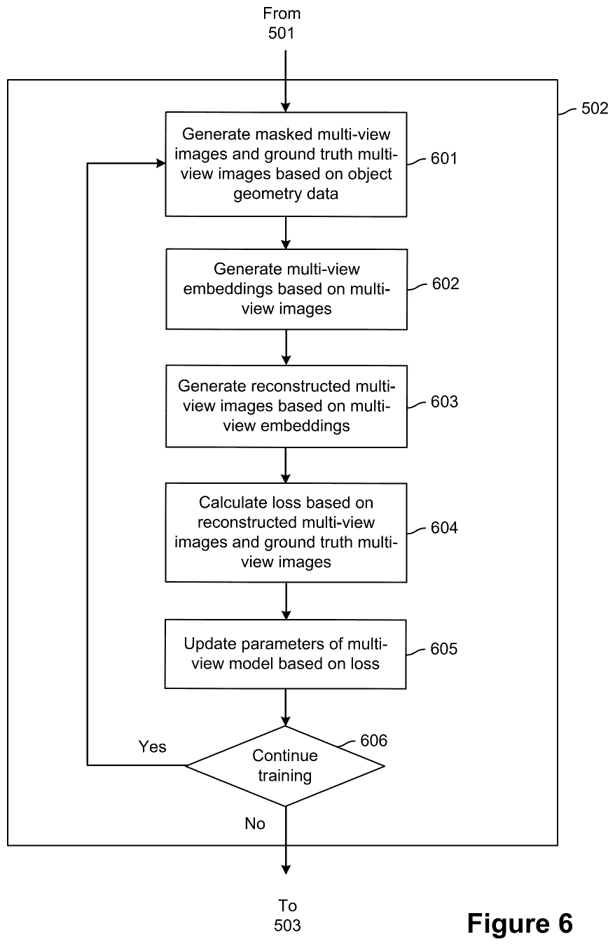

At step 502, model trainer 115 trains multi-view model 119 based on object geometry data 124 and stores the trained multi-view encoder 125. In some embodiments, multi-view renderer 116 processes object geometry data 124 and generates masked multi-view images 301 and ground truth multi-view images 302. Multi-view encoder 125 processes masked multi-view images 301 and generates multi-view embeddings 303. Decoder 117 processes multi-view embeddings 303 and generates reconstructed multi-view images 304. Loss calculator 118 compares reconstructed multi-view images 304 and ground truth multi-view images 302 and calculates loss 305. Model trainer 115 uses loss 305 to iteratively update the parameters of multi-view model 119. Step 502 of the method 500 is described in greater detail in conjunction with FIG. 6.

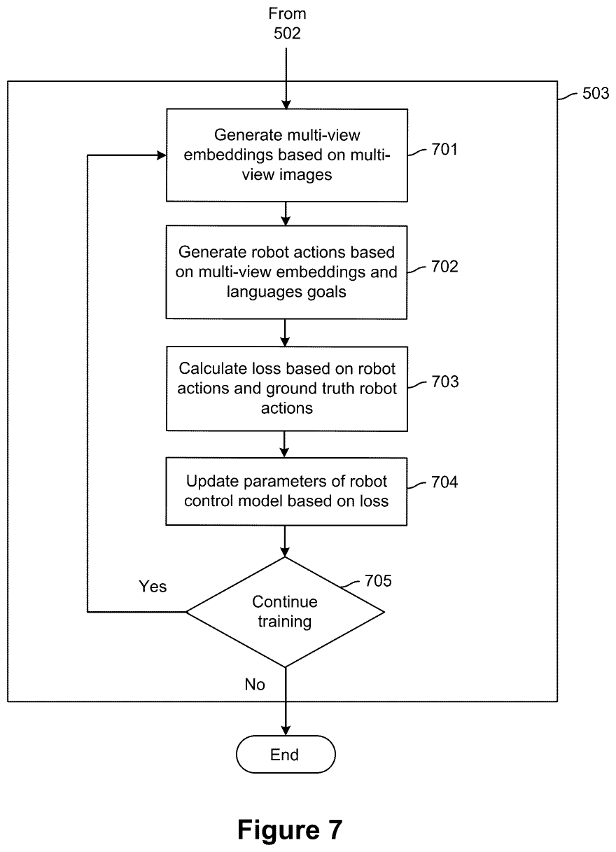

At step 503, model trainer 115 trains robot control model 123, using the trained multi-view encoder 125, based on robot demonstration data 127. The trained multi-view encoder 125 processes multi-view images 310 included in robot demonstration data 127 and generates multi-view embeddings 303. Action decoder 126 processes language goals 311 included in robot demonstration data 127 and multi-view embeddings 303 and generates robot actions 313. Loss calculator 118 compares robot actions 313 and ground truth robot actions 312 included in robot demonstration data 127 and calculates loss 314. Model trainer 115 uses loss 314 to update the parameters of robot control model 123. Step 503 of the method 500 is described in greater detail in conjunction with FIG. 7.

FIG. 6 is a flow diagram of method steps for training a multi-view model 119, according to various embodiments. Although the method steps are described in conjunction with the systems of FIGS. 1-4, persons skilled in the art will understand that any system configured to perform the method steps in any order falls within the scope of the present disclosure.

As shown, step 502 of method 500 begins with step 601, where multi-view renderer 116 generates masked multi-view images 301 and ground truth multi-view images 302 based on object geometry data 124. In some embodiments, multi-view renderer 116 [symbol] maps one or more posed images included in object geometry data 124 into one or more virtual images (e.g., ground truth multi-view images 301), by constructing a point cloud and rendering the point cloud from one or more views. In various embodiments, multi-view renderer 116 is agnostic to the poses of the RGBD virtual cameras used to construct the point cloud. For example, the point cloud can be obtained from a combination of third-person cameras around the workspace surrounding an object included in object geometry data 124. Multi-view renderer 116 then renders the point cloud using the one or more virtual cameras placed at orthogonal locations around the object, such as virtual cameras placed at the top, left, right, front, and back of the object. In some examples, each virtual image includes a plurality of channels (e.g., 10 channels) including RGB channels (e.g., 3 channels), depth channels (e.g., 1 channel), 3D point coordinate in world frame channels (e.g., 3 channels), and 3D point coordinate channels in camera sensor frame (e.g., 3 channels). In some embodiments, multi-view renderer 116 randomly masks out a subset of visual tokens included in one or more virtual images {I₁, . . . , I_{N}} and generates masked multi-view images 301

$$\{ {I}_{1}^{′} , … , {I}_{N}^{′} \} .$$

For example, multi-view renderer 116 could tokenize virtual images using 10×10 pixel patches and apply a masking probability of 0.75 to the patches.

At step 602, multi-view encoder 125 generates multi-view embeddings 303 based on multi-view images 301. In some embodiments, multi-view encoder 125 [symbol] maps masked multi-view images 301 into a latent embedding z∈ [symbol] as described in Equation 1. In some examples, multi-view encoder 125 can include a transformer with 8 layers, 8 attention heads, and a hidden layer dimension of 1024.

At step 603, decoder 117 generates reconstructed multi-view images 304 based on multi-view embeddings 303. In some embodiments, decoder 117 includes a lightweight masked autoencoder [symbol] which reconstructs the multi-view image {I₁, . . . , I_{S}} from the embedding z as described by Equation 2.

At step 604, loss calculator 118 calculates loss 305 based on reconstructed multi-view images 304 and ground truth multi-view images 302. In some examples, loss calculator 118 calculates a pixel-wise reconstruction loss as described in Equation 3.

At step 605, model trainer 115 updates parameters of multi-view model 119 based on loss 305. In various embodiments, model trainer 115 trains multi-view model 119 to jointly learn to reconstruct all ground truth multi-view images 302 and the masking patterns are varied during training. In some embodiments, model trainer 115 splits object geometry data 124 into a training set and a validation set. In some embodiments, model trainer 115 processes the training set in batches, where each batch consists of a small subset of the training set. For example, model trainer 115 can use a batch size of 3, meaning that three samples are processed in parallel before updating the parameters of multi-view model 119. In some embodiments, model trainer 115 uses various optimization techniques, such AdamW, to update the parameters of multi-view model 119 based on loss 305. In some examples, model trainer 115 uses a learning rate of 0.0001 and a weight decay of 0.01 for AdamW optimization.

At step 606, model trainer 115 checks whether to continue training. In some embodiments, model trainer 115 determines when to stop training multi-view model 119 based on various predefined stopping criteria. For example, model trainer 115 could train multi-view model 119 for a fixed number of epochs, such as 15 epochs. In other embodiments, model trainer 115 can use an early stopping mechanism, where training stops whenever the loss does not improve for a certain number of consecutive epochs, which prevents overfitting and permits that multi-view model 119 does not continue training beyond the point of diminishing returns. Additionally, model trainer 115 can monitor other metrics for stopping, such as reconstruction accuracy or generalization performance. Whenever model trainer 115 determines to continue training, step 502 of method 500 returns to step 601. Whenever model trainer 115 determines not to continue training, model trainer 115 stores the trained multi-view encoder 125 in datastore 120 or elsewhere.

FIG. 7 is a flow diagram of method steps for training a robot control model 123 using a trained multi-view encoder 125, according to various embodiments. Although the method steps are described in conjunction with the systems of FIGS. 1-4, persons skilled in the art will understand that any system configured to perform the method steps in any order falls within the scope of the present disclosure.

As shown, step 503 of method 500 begins with step 701, where the trained multi-view encoder 125 generates multi-view embeddings 303 based on multi-view images 310. In some examples, the trained multi-view encoder 125 [symbol] generates multi-view embeddings 303 z based on multi-view images 310 I₁, . . . , I_{N} as described by Equation 5.

At step 702, action decoder 117 generates robot actions 313 based on multi-view embeddings 303 and languages goals 311. In some examples, action decoder 117 [symbol] maps multi-view embeddings 303 z to robot actions 313 as described in Equation 6.

At step 703, loss calculator 118 calculates loss 314 based on robot actions 313 and ground truth robot actions 312. In some embodiments, loss calculator 118 computes loss 314 using a combination of loss functions tailored to various aspects of robot actions 313. In some examples, for rotation, loss calculator 118 calculates a cross-entropy loss function applied to each of the Euler angles to minimize the difference between predicted rotations included in robot actions 313 and ground-truth rotations included in ground truth robot actions 312. For the gripper state, loss calculator 118 applies a binary classification loss. In some embodiments, loss calculator 118 calculates a binary classification loss for a collision indicator, which predicts whether the robot action 313 would result in a collision with an object or the environment.

At step 704, model trainer 115 updates parameters of robot control model 123 based on loss 314. In some embodiments, model trainer 115 uses various optimization techniques, such Lamb, to update the parameters of robot control model 123. In some embodiments, model trainer 115 uses robot demonstration data 127 in fixed-size batches (e.g., batches of size 3) during training. In some embodiments, model trainer 115 trains robot control model 123 using a small learning rate (e.g., 1e-4) with a warmup phase to stabilize early training.

At step 705, model trainer 115 checks whether to continue training. In some embodiments, model trainer 115 implements an early stopping mechanism, where training halts when a loss does not improve for a specified number of consecutive epochs. Additionally, model trainer 115 can monitor performance metrics such as task success rate, robot trajectory accuracy, and action prediction consistency to determine when the robot control model 123 has converged. Whenever model trainer 115 determines to continue training, step 503 of method 500 returns to step 701. Whenever model trainer 115 determines not to continue training, model trainer 115 stores the trained robot control model 123 in data store 120 or elsewhere.

FIG. 8 is the flow diagram of method steps for controlling a robot 160 using a trained robot control model 123, according to various embodiments. Although the method steps are described in conjunction with the systems of FIGS. 1-4, persons skilled in the art will understand that any system configured to perform the method steps in any order falls within the scope of the present disclosure.

A method 800 begins with step 801, where robot control application 146 receives sensor data 402 and language goals 403. In some embodiments, robot control application 146 receives language goals 403 from one or more I/O devices (not shown) and receives sensor data 402 from sensors 180. As described, language goals 403 represent task descriptions or high-level instructions provided in natural language, specifying the intended robot action or outcome of a robotic task. In some embodiments, sensors 180 can include cameras positioned on and/or around the robot, such as head-mounted cameras, wrist cameras, and/or external third-person cameras placed at predefined viewpoints, and the cameras can capture RGB and depth data.

At step 802, sensor data processing module 401 generates multi-view images 404 based on sensor data 402. In some embodiments, sensor data processing module 401 normalizes and preprocesses multi-view images 404 before passing multi-view images 404 to the trained robot control model 123. The preprocessing can include depth normalization, background filtering, image resizing, and/or applying transformations to align images across different viewpoints. In some embodiments, multi-view images 404 include RGB-D (red, blue, green, and depth) images generated using one or more virtual cameras from different viewpoints. As described, sensors 180 can include cameras positioned on and/or around the robot, such as head-mounted cameras, wrist cameras, and/or external third-person cameras placed at predefined viewpoints, and the cameras can capture RGB and depth data. Sensor data processing module 401 can then map the captured RGB and depth data into one or more virtual images (e.g., multi-view images 404) by constructing a point cloud and rendering the point cloud from one or more views using virtual cameras at predefined locations (e.g., top, left, right, front, and back virtual cameras), similar to the description above with respect to the multi-view renderer 116 in FIG. 3A.

At step 803, robot control application 146 generates, using trained robot control model 123, robot actions based on multi-view images 404 and language goals 403. In various embodiments, trained robot control model 123 processes multi-view images 404 and language goals 403 and outputs robot actions.

At step 804, robot control application 146, based on the robot actions, generates controls for robot 160 to perform at least part of a robotic task. In some embodiments, Robot control application 146 processes the robot actions and generates one or more controls for robot 160 to complete at least part of a task. In some embodiments, robot control application 146 uses various motion planning techniques, such as inverse kinematics and/or the like, to generate one or more controls based on the robot actions. In some embodiments, robot control application 146 includes real-time feedback from sensors 180 to dynamically adjust the robot actions based on unexpected changes in the environment, such as the displacement of objects or obstacles.

At step 805, robot control application 146 causes robot 160 to move based on the controls. In some embodiments, robot control application 146 sends low-level motor commands to the actuators of robot 160, or sends commands based on the controls to a low-level controller that generates low-level motor commands, enabling precise execution of the controls.

In sum, techniques are disclosed for vision-based robot control using multi-view pretraining. In various embodiments, a model trainer trains a robot control model, which is a machine learning model, in two stages. In a first stage, also referred to herein as “pretraining,” the model trainer trains a multi-view model, which is another machine learning model, using object geometry data. In some embodiments, the multi-view model includes a multi-view encoder and a decoder. During the first stage of training, a multi-view renderer processes object geometry data and generates masked multi-view images, which are images rendered using virtual cameras from different viewpoints, and corresponding ground-truth multi-view images. The multi-view encoder processes the masked multi-view images and generates multi-view embeddings. The decoder processes the multi-view embeddings and generates reconstructed multi-view images. A loss calculator compares the reconstructed multi-view images and the ground-truth multi-view images to calculate a first loss, such as a reconstruction loss. The model trainer uses the first loss to iteratively update the parameters of the multi-view model. Once the multi-view model is trained, the model trainer stores the trained multi-view encoder for the second stage of training. In the second stage, the model trainer trains the robot control model using robot demonstration data, which includes multi-view images, language goals, and ground truth robot actions. The robot control model includes the trained multi-view encoder and an action decoder. During the second stage of training, the trained multi-view encoder processes the multi-view images from robot demonstration data and generates multi-view embeddings. The action decoder processes the multi-view embeddings and the language goals and generates robot actions. The loss calculator compares the robot actions and the ground-truth robot actions to calculate a second loss. The model trainer then uses the second loss to iteratively update the parameters of the robot control model. Once the robot control model is trained, the trained robot control model can be used to generate robot actions to cause a robot to perform at least part of a task.

At least one technical advantage of the disclosed techniques relative to the prior art is that the disclosed techniques generate images from 3D object geometry data rather than 2D image data, allowing a robot control model to understand the underlying 3D structures of scenes. Additionally, the disclosed techniques pretrain a multi-view encoder on large-scale 3D datasets before training a robot control model that includes the multi-view encoder on robotics data, which can be limited. Pretraining the multi-view encoder on large-scale 3D datasets allows the trained robot control model, which includes the multi-view encoder, to generalize to novel situations and objects that are not included in the limited robotics data. Accordingly, the trained robot control model can correctly control a robot to perform tasks in more scenarios than prior art approaches are able to. These technical advantages provide one or more technological improvements over prior art approaches.
1. In some embodiments, a computer-implemented method for training a robot control model comprises performing, based on a plurality of multi-view images that have been masked, one or more operations to train a first untrained machine learning model to generate a first trained machine learning model that comprises a trained encoder, wherein the first trained machine learning model is trained to generate a plurality of reconstructions of the plurality of multi-view images prior to being masked, and performing, based on robot demonstration data, one or more operations to train a second untrained machine learning model that comprises the trained encoder to generate a second trained machine learning model, wherein the second trained machine learning model is trained to control a robot to perform at least part of a task.
2. The computer-implemented method of clause 1, further comprising generating, based on object geometry data, the plurality of multi-view images, and masking out at least one portion of each image included in the plurality of multi-view images.
3. The computer-implemented method of clauses 1 or 2, wherein generating the plurality of multi-view images comprises generating, based on the object geometry data, a point cloud, and rendering the point cloud using a plurality of virtual cameras to generate the plurality of multi-view images.
4. The computer-implemented method of any of clauses 1-3, wherein masking out at least one portion of each image comprises randomly masking out one or more visual tokens of the image.
5. The computer-implemented method of any of clauses 1-4, wherein performing one or more operations to train the first untrained machine learning model comprises generating, based on the plurality of multi-view images that have been masked, one or more multi-view embeddings using an untrained encoder included in the untrained machine learning model, generating, based on the one or more multi-view embeddings, another plurality of reconstructions of the multi-view images using a decoder included in the untrained machine learning model, calculating, based on the another plurality of reconstructions and the plurality of multi-view images, a loss, and updating, based on the loss, one or more parameters of the first untrained machine learning model.
6. The computer-implemented method of any of clauses 1-5, wherein the loss is a pixel-wise reconstruction loss that measures differences between pixels in the another plurality of reconstructions and pixels in the plurality of multi-view images.
7. The computer-implemented method of any of clauses 1-6, wherein the decoder comprises a masked autoencoder.
8. The computer-implemented method of any of clauses 1-7, wherein the robot demonstration data comprises another plurality of multi-view images, one or more language goals, and one or more ground truth robot actions.
9. The computer-implemented method of any of clauses 1-8, wherein performing one or more operations to train the second untrained machine learning model comprises generating, based on the another plurality of multi-view images, one or more multi-view embeddings using the trained encoder, generating, based on the one or more multi-view embeddings and the one or more language goals, one or more robot actions using a decoder included in the second untrained machine learning model, calculating, based on the one or more robot actions and the one or more ground truth robot actions, a loss, and updating, based on the loss, one or more parameters of the second untrained machine learning model.
10. The computer-implemented method of any of clauses 1-9, further comprising receiving sensor data from one or more sensors and one or more language goals, generating, based on the sensor data, another plurality of multi-view images, generating, based on the another plurality of multi-view images and the one or more language goals, one or more robot actions using the second trained machine learning model, generating, based on the one or more robot actions, one or more controls, and causing the robot to move based on the one or more controls.
11. In some embodiments, one or more non-transitory computer readable media store instructions that, when executed by one or more processors, cause the one or more processors to perform the steps of performing, based on a plurality of multi-view images that have been masked, one or more operations to train a first untrained machine learning model to generate a first trained machine learning model that comprises a trained encoder, wherein the first trained machine learning model is trained to generate a plurality of reconstructions of the plurality of multi-view images prior to being masked, and performing, based on robot demonstration data, one or more operations to train a second untrained machine learning model that comprises the trained encoder to generate a second trained machine learning model, wherein the second trained machine learning model is trained to control a robot to perform at least part of a task.
12. The one or more non-transitory computer-readable media of clause 11, wherein the instructions, when executed by the one or more processors, further cause the one or more processors to perform the step of generating, based on object geometry data, the plurality of multi-view images, and masking out at least one portion of each image included in the plurality of multi-view images.
13. The one or more non-transitory computer-readable media of clauses 11 or 12, wherein the plurality of multi-view images are rendered using a plurality of virtual cameras at predefined viewpoints around the object geometry data.
14. The one or more non-transitory computer-readable media of any of clauses 11-13, wherein performing one or more operations to train the first untrained machine learning model comprises generating, based on the plurality of multi-view images that have been masked, one or more multi-view embeddings using an untrained encoder included in the untrained machine learning model, generating, based on the one or more multi-view embeddings, another plurality of reconstructions of the multi-view images using a decoder included in the untrained machine learning model, calculating, based on the another plurality of reconstructions and the plurality of multi-view images, a loss, and updating, based on the loss, one or more parameters of the first untrained machine learning model.
15. The one or more non-transitory computer-readable media of any of clauses 11-14, wherein the robot demonstration data comprises another plurality of multi-view images, one or more language goals, and one or more ground truth robot actions.
16. The one or more non-transitory computer-readable media of any of clauses 11-15, wherein performing one or more operations to train the second untrained machine learning model comprises generating, based on the another plurality of multi-view images, one or more multi-view embeddings using the trained encoder, generating, based on the one or more multi-view embeddings and the one or more language goals, one or more robot actions using a decoder included in the second untrained machine learning model, calculating, based on the one or more robot actions and the one or more ground truth robot actions, a loss, and updating, based on the loss, one or more parameters of the second untrained machine learning model.
17. The one or more non-transitory computer-readable media of any of clauses 11-16, wherein the instructions, when executed by the one or more processors, further cause the one or more processors to perform the steps of receiving sensor data from one or more sensors and one or more language goals, generating, based on the sensor data, another plurality of multi-view images, generating, based on the another plurality of multi-view images and the one or more language goals, one or more robot actions using the second trained machine learning model, generating, based on the one or more robot actions, one or more controls, and causing the robot to move based on the one or more controls.
18. The one or more non-transitory computer-readable media of any of clauses 11-17, wherein the robot is one of a physical robot or a simulated robot in a virtual environment.
19. The one or more non-transitory computer-readable media of any of clauses 11-18, wherein the trained encoder comprises at least one of one or more transformer layers, one or more attention heads, or one or more hidden layers.
20. In some embodiments, a system comprises one or more memories storing instructions, and one or more processors that are coupled to the one or more memories and, when executing the instructions, are configured to perform, based on a plurality of multi-view images that have been masked, one or more operations to train a first untrained machine learning model to generate a first trained machine learning model that comprises a trained encoder, wherein the first trained machine learning model is trained to generate a plurality of reconstructions of the plurality of multi-view images prior to being masked, and perform, based on robot demonstration data, one or more operations to train a second untrained machine learning model that comprises the trained encoder to generate a second trained machine learning model, wherein the second trained machine learning model is trained to control a robot to perform at least part of a task.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for training a robot control model, the method comprising:
performing, based on a plurality of multi-view images that have been masked, one or more operations to train a first untrained machine learning model to generate a first trained machine learning model that comprises a trained encoder, wherein the first trained machine learning model is trained to generate a plurality of reconstructions of the plurality of multi-view images prior to being masked; and
performing, based on robot demonstration data, one or more operations to train a second untrained machine learning model that comprises the trained encoder to generate a second trained machine learning model, wherein the second trained machine learning model is trained to control a robot to perform at least part of a task.

2. The computer-implemented method of claim 1, further comprising:
generating, based on object geometry data, the plurality of multi-view images; and
masking out at least one portion of each image included in the plurality of multi-view images.

3. The computer-implemented method of claim 2, wherein generating the plurality of multi-view images comprises:
generating, based on the object geometry data, a point cloud; and
rendering the point cloud using a plurality of virtual cameras to generate the plurality of multi-view images.

4. The computer-implemented method of claim 2, wherein masking out at least one portion of each image comprises randomly masking out one or more visual tokens of the image.

5. The computer-implemented method of claim 1, wherein performing one or more operations to train the first untrained machine learning model comprises:
generating, based on the plurality of multi-view images that have been masked, one or more multi-view embeddings using an untrained encoder included in the untrained machine learning model;
generating, based on the one or more multi-view embeddings, another plurality of reconstructions of the multi-view images using a decoder included in the untrained machine learning model;
calculating, based on the another plurality of reconstructions and the plurality of multi-view images, a loss; and
updating, based on the loss, one or more parameters of the first untrained machine learning model.

6. The computer-implemented method of claim 5, wherein the loss is a pixel-wise reconstruction loss that measures differences between pixels in the another plurality of reconstructions and pixels in the plurality of multi-view images.

7. The computer-implemented method of claim 5, wherein the decoder comprises a masked autoencoder.

8. The computer-implemented method of claim 1, wherein the robot demonstration data comprises another plurality of multi-view images, one or more language goals, and one or more ground truth robot actions.

9. The computer-implemented method of claim 8, wherein performing one or more operations to train the second untrained machine learning model comprises
generating, based on the another plurality of multi-view images, one or more multi-view embeddings using the trained encoder;
generating, based on the one or more multi-view embeddings and the one or more language goals, one or more robot actions using a decoder included in the second untrained machine learning model;
calculating, based on the one or more robot actions and the one or more ground truth robot actions, a loss; and
updating, based on the loss, one or more parameters of the second untrained machine learning model.

10. The computer-implemented method of claim 1, further comprising:
receiving sensor data from one or more sensors and one or more language goals;
generating, based on the sensor data, another plurality of multi-view images;
generating, based on the another plurality of multi-view images and the one or more language goals, one or more robot actions using the second trained machine learning model;
generating, based on the one or more robot actions, one or more controls; and
causing the robot to move based on the one or more controls.

11. One or more non-transitory computer readable media storing instructions that, when executed by one or more processors, cause the one or more processors to perform the steps of:
performing, based on a plurality of multi-view images that have been masked, one or more operations to train a first untrained machine learning model to generate a first trained machine learning model that comprises a trained encoder, wherein the first trained machine learning model is trained to generate a plurality of reconstructions of the plurality of multi-view images prior to being masked; and
performing, based on robot demonstration data, one or more operations to train a second untrained machine learning model that comprises the trained encoder to generate a second trained machine learning model, wherein the second trained machine learning model is trained to control a robot to perform at least part of a task.

12. The one or more non-transitory computer-readable media of claim 11, wherein the instructions, when executed by the one or more processors, further cause the one or more processors to perform the step of:
generating, based on object geometry data, the plurality of multi-view images; and
masking out at least one portion of each image included in the plurality of multi-view images.

13. The one or more non-transitory computer-readable media of claim 12, wherein the plurality of multi-view images are rendered using a plurality of virtual cameras at predefined viewpoints around the object geometry data.

14. The one or more non-transitory computer-readable media of claim 11, wherein performing one or more operations to train the first untrained machine learning model comprises:
generating, based on the plurality of multi-view images that have been masked, one or more multi-view embeddings using an untrained encoder included in the untrained machine learning model;
generating, based on the one or more multi-view embeddings, another plurality of reconstructions of the multi-view images using a decoder included in the untrained machine learning model;
calculating, based on the another plurality of reconstructions and the plurality of multi-view images, a loss; and
updating, based on the loss, one or more parameters of the first untrained machine learning model.

15. The one or more non-transitory computer-readable media of claim 11, wherein the robot demonstration data comprises another plurality of multi-view images, one or more language goals, and one or more ground truth robot actions.

16. The one or more non-transitory computer-readable media of claim 15, wherein performing one or more operations to train the second untrained machine learning model comprises:
generating, based on the another plurality of multi-view images, one or more multi-view embeddings using the trained encoder;
generating, based on the one or more multi-view embeddings and the one or more language goals, one or more robot actions using a decoder included in the second untrained machine learning model;
calculating, based on the one or more robot actions and the one or more ground truth robot actions, a loss; and
updating, based on the loss, one or more parameters of the second untrained machine learning model.

17. The one or more non-transitory computer-readable media of claim 11, wherein the instructions, when executed by the one or more processors, further cause the one or more processors to perform the steps of:
receiving sensor data from one or more sensors and one or more language goals;
generating, based on the sensor data, another plurality of multi-view images;
generating, based on the another plurality of multi-view images and the one or more language goals, one or more robot actions using the second trained machine learning model;
generating, based on the one or more robot actions, one or more controls; and
causing the robot to move based on the one or more controls.

18. The one or more non-transitory computer-readable media of claim 11, wherein the robot is one of a physical robot or a simulated robot in a virtual environment.

19. The one or more non-transitory computer-readable media of claim 11, wherein the trained encoder comprises at least one of one or more transformer layers, one or more attention heads, or one or more hidden layers.

20. A system comprising:
one or more memories storing instructions, and
one or more processors that are coupled to the one or more memories and, when executing the instructions, are configured to:
perform, based on a plurality of multi-view images that have been masked, one or more operations to train a first untrained machine learning model to generate a first trained machine learning model that comprises a trained encoder, wherein the first trained machine learning model is trained to generate a plurality of reconstructions of the plurality of multi-view images prior to being masked, and
perform, based on robot demonstration data, one or more operations to train a second untrained machine learning model that comprises the trained encoder to generate a second trained machine learning model, wherein the second trained machine learning model is trained to control a robot to perform at least part of a task.
